(19) United States
(12) Patent Application Publication
(10) Pub. No.: US 2002/0147962 A1
(43) Pub. Date: Oct. 10, 2002

(54) Method and system for incorporating legacy applications into a distributed data processing environment

(75) Inventor: Iwao Hatanaka, Acton, MA (US)

Correspondence Address: Douglas A. Lashmit, c/o IBM Corporation Intellectual Property, Law Department (Department QPZ/201), 8501 IBM Drive, Charlotte, NC, 28262, US

(73) Assignee: International Business Machines Corporation, Armonk, NY (US)

(21) Appl. No.: 09/781,615

(22) Filed: Feb. 12, 2001

(51) Int. Cl. G06F 9/44

(52) U.S. Cl. 717/102; 717/103

(57) ABSTRACT

A system and method incorporating existing or legacy software applications into a distributed data processing environment by encapsulating each legacy application into a new application which adheres to the Enterprise JavaBeans (EJB) interface specifications. The new application with the EJB interfaces allows use of the application in a distributed processing environment such as the Internet or a virtual private network such as an intranet.

### CROSS REFERENCE TO RELATED PATENTS

The present invention is related to the following patents which are specifically incorporated herein by reference:

Pending patent application Ser. No. 09/409,345 (docket CHA9-1999-0004) filed Sep. 30, 1999 by Cessna et al. entitled “Framework for Dynamic Hierarchical Grouping and Calculation based on Multidimensional Characteristics” and assigned to the assignee of the present invention. This patent is sometimes referred to herein as the Framework Patent.

Pending patent application Ser. No. 09/491,834 (docket CHA9-99-014) filed Jan. 26, 2000 by C. Bialik et al. entitled “Method and System for Database Management for Supply Chain Management” and assigned to the assignee of the present invention. This patent is sometimes referred to herein as the Database Patent.

Patent application Ser. No. (to be assigned) (docket CHA9-99-015) filed concurrently by Iwao Hatanaka entitled “Method and System for Automated Session Resource Clean-up in a Distributed Client-Server Environment” and assigned to the assignee of the present patent. This patent is sometimes referred to herein as the Clean-up Patent.

### BACKGROUND OF THE INVENTION

1. Field of the Invention

The present invention is an improved system and method for incorporating one or more legacy software applications into a distributed data processing system such as may be found in a client-server environment. More particularly, the present invention relates to a method and system for incorporating legacy data processing applications into a distributed or client server environment by providing a system for wrapping the application with a component-based front end which complies with specified rules and uses a common naming and arrangement system to allow for interchange of data between the applications over a network.

2. Background Art

Many large organizations had processed the data collected and used to run the organization from a central data processing facility in which at least one mainframe computer was provided with application program(s) and database(s) and generated the information necessary to run the organization from the central facility. This data processing involved the use of large, frequently custom-made, software programs running on a large, local computer system. Such a system is frequently referred to as enterprise computing or the mainframe world.

However, in recent years, many factors have evolved to change data processing from a mainframe world in which a large application is run on a single mainframe to a distributed data processing system or one which is referred to as a client-server environment in which applications and databases are located at diverse locations and processing occurs on a plurality of (more but smaller and less expensive) data processing systems using a data processing network to interconnect the plurality of data processing systems.

In a client-server environment, a local terminal (sometimes referred to as a client) is connected to a server for the purpose of processing information in a distributed environment. Frequently, the client is itself a data processing system communicating with a server which is generally a data processing system with increased resources when compared with the client, including applications and data which are not available at the client location. Such a system is described in some detail in the Framework Patent referenced above.

The client is frequently located at a distance from the server and communicates with the server using telecommunication facilities, e.g., including hardware and software operating over phone service such as might be provided using telephone lines, either alone or in combination with other communication systems such as satellite or microwave communications.

The problem with the change in data processing from a central or enterprise computing to distributed or client-server computing is that the new system was not born with a complete set of applications to replace those which has been associated with the central or enterprise computing and there is no convenient way to migrate from an enterprise or centrally-located single application (sometimes also referred to as a “legacy” application) to a client-server application which uses distributed processing over a data processing network.

A client-server or distributed application must comply with a rather rigid set of rules or guidelines as to its interface with the data transmission network and with other applications. A legacy application is not so limited and, in fact, since it only must be internally consistent, some legacy applications follow good programming techniques (such as suggested documentation and interface information) for mainframe applications while other legacy applications do not. Re-writing legacy applications such that they “fit” into the new computing environment can take extensive time and resources, and such time and resources are costly and can introduce errors.

Accordingly, the prior art systems have undesirable disadvantages and limitations.

### SUMMARY OF THE INVENTION

The present invention overcomes the limitations and disadvantages of the prior art systems by providing a system and method for integrating a legacy application into a distributed, client-server environment.

The present invention has the advantage that it is simple and easy to implement to allow for legacy applications to be used in a distributed data processing environment with remote calls from clients.

The present invention allows for a legacy application to be modified and used in a distributed data processing environment.

The present invention involves setting up a common set of variables which are used uniformly across the applications.

The present system involves taking a legacy application and providing it with a component-based front end or interface which used Enterprise JavaBeans (EJB) interface specification and encapsulates the existing legacy application functionality into distributable components. This interface then uses a common dictionary of terms, allowing it to interface with other applications (particularly those in a distributed processing environment).

The present system also allows for a table which identifies the variables in an application, allowing for the uniform use of those variables. The present invention also allows the establishment of a predetermined order for variables to be communicated to an application, allowing a more efficient communication between a client and a server.

Other objects and advantages of the present invention will be apparent to those skilled in the relevant art in view of the following description of the preferred embodiment, taken together with the accompanying drawings and the appended claims.

### BRIEF DESCRIPTION OF THE DRAWINGS

The present invention is an improved system and method for integrating a legacy application into a distributed, client-server environment, an embodiment of which is illustrated with reference to the accompanying drawings in which:

FIG. 1 depicts a data processing system of the prior art in which a large legacy data processing application is installed on a single computer for processing data for an organization (sometime referred to as an enterprise computer or mainframe model for data processing);

FIG. 2 depicts a communications system representative of the preferred embodiment of the present invention wherein a plurality of smaller distributed data processing systems are coupled to a data transmission network;

FIG. 3 is an illustration of an application used in the distributed system depicted in FIG. 2

FIG. 4 is a flow diagram of the preferred embodiment of the present invention;

FIG. 5 is an illustration of an application using the present invention; and

FIG. 6 is a view of the process of using an object broker naming service to use the present invention.

### DETAILED DESCRIPTION OF THE PREFERRED EMBODIMENT

In the following description of the preferred embodiment, the best implementation of practicing the invention presently known to the inventors will be described with some particularity. However, this description is intended as a broad, general teaching of the concepts of the present invention in a specific embodiment but is not intended to be limiting the present invention to that as shown in this embodiment, especially since those skilled in the relevant art will recognize many variations and changes to the specific structure and operation shown and described with respect to these figures.

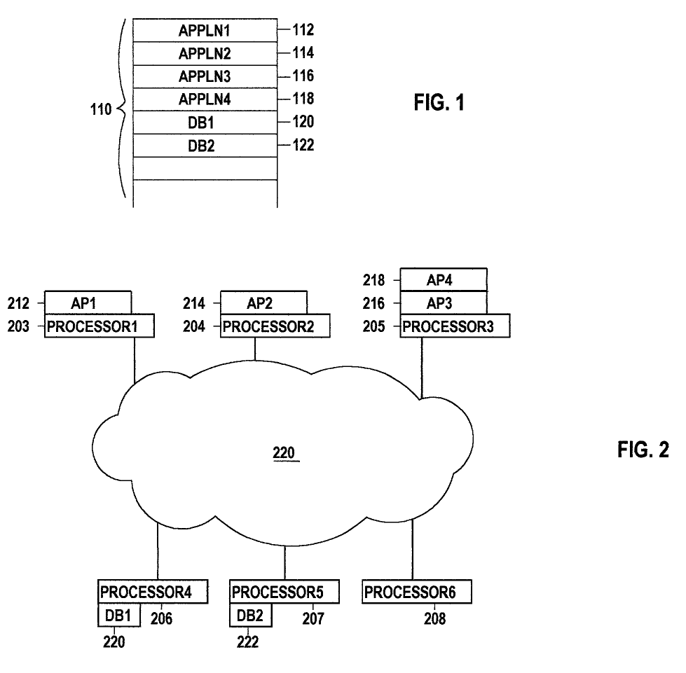

FIG. 1 illustrates one form of data processing system for an enterprise where a central computer or data processing system 110 includes the necessary data processing application(s) and related information such as database(s). As shown in this FIG. 1, four applications (other application components) and two databases are shown on the single central computer or data processing system 110.

The data processing system 110 shown in FIG. 1 is often referred to as a mainframe or enterprise system or centralized processor. Applications for such a system were generally written in a high level computer programming language such as COBOL and interface primarily, if not exclusively, with other applications written by the same group of programmers and running on the same computer or a closely located and similarly configured computer system. While some of these applications for such an enterprise data processing system are sometimes written by different organizations, in many cases they originate with a single organization and may have been customized for the particular customer for whom the programs have been installed. (Some large organizations even may have created their own applications using a roll-your-own system, and may have customized and modified that system over the years so that it is truly unique and adapted to the particular data processing needs of the single customer using it.) Such a system frequently resides in a data processing operation of a large corporation and, from past years when such systems included a raised floor and glass walls, is sometimes referred to as a “glass house” data processing system and application. Such a system is frequently run by a central data processing or information technology staff in a centralized fashion, where all of the data is sent in to a single location, processed and then returned to the using locations in the form of final reports.

As shown in this FIG. 1, such a centralized system 110 may include a first application (or application component) APPLN1 represented by numeral 112, a second application APPLN2 represented by numeral 114, a third application APPLN3 represented by the reference numeral 116, a fourth application APPLN4 represented by the reference numeral 116 and a first database DB1 represented by the reference numeral 120 and a second database DB2 represented by the reference numeral 122. As shown in this figure, the data processing system is used for supply chain management and inventory control and the first application APPLN1 is an inventory application, the second application APPLN2 is a promotion application, the third application APPLN3 is a sales application and the fourth application APPLN4 is an ordering application. The first database DB1 contains details of goods on hand and the second database DB2 contains details of store sales history, or what goods have been sold in the past in what store.

These various applications may be parts of a single integrated application, along with the associated databases, or they may written as separate application modules which run on the single processor 110 as shown in a centralized processing environment of FIG. 1.

Recently, however, due to changes in the available systems and the increased capacity of networks and smaller processors, a distributed processor system has come into existence and, with the increase in speeds and the decreases in relative costs, has become an attractive model for many data processing systems. Along with the change in the types of data processing has come a change in data processing language: a new language for application programs called object oriented programming languages such as C++ and Ada. Such programming languages use an interface specification which allows for interchange of data through defined interfaces. Unfortunately, the advent of such a distributed data processing environment and the new programming languages have not meant that a fill range of applications have been written to exploit the distributed data processing, nor is there a convenient way to take an application written for and installed on a central or enterprise server and make it into an application suitable for processing in a distributed data processing environment.

FIG. 2 illustrates components of a data processing system of the type which is seen in a distributed data processing system. As shown in this FIG. 2, many individual processors are coupled to a data transmission network 202 and perform the various operations in a distributed or client-server environment. As shown in this FIG. 2 for illustrative purposes, six processors are coupled to the network 202 and called PROCESSOR1 203, PROCESSOR2 204, PROCESSOR 3 205, PROCESSOR 4 206, PROCESSOR 5 207 and PROCESSOR6 208. The PROCESSOR1 203 includes a first application AP1 212 while the PROCESSOR2 204 includes a second application AP2 214. The PROCESSOR3 205 includes two applications, AP3 216 and AP4 218. The PROCESSOR4 206 has a first database DB1 220 and the PROCESSOR5 has a second database DB2 222 mounted on it. Each of these applications may be related to the associated applications of FIG. 1 through a transform which will be explained later in this document to take an enterprise or central application and convert it into an application suitable for use in a distributed data processing environment of the present invention using client-server data processing.

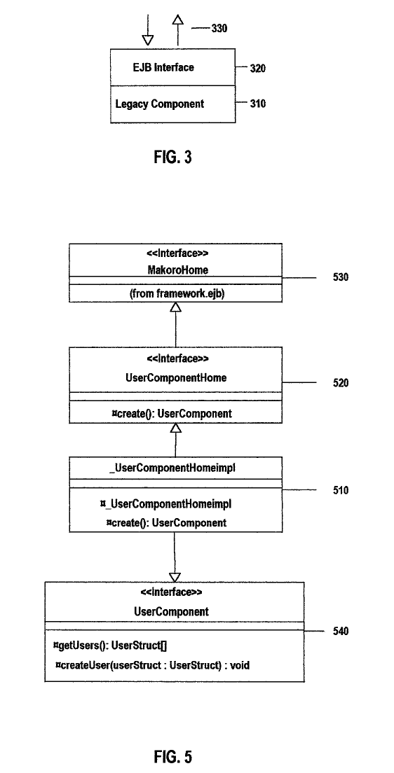

FIG. 3 illustrates conceptually the converted application of FIG. 1 used in a distributed data processing system of FIG. 2. The legacy application is represented by the reference numeral 310 with a component-based front end or interface 320 conforming to the EJB interface specification which has been added to allow the legacy application 310 to communicate in a distributed data processing system illustrated by the arrows 330.

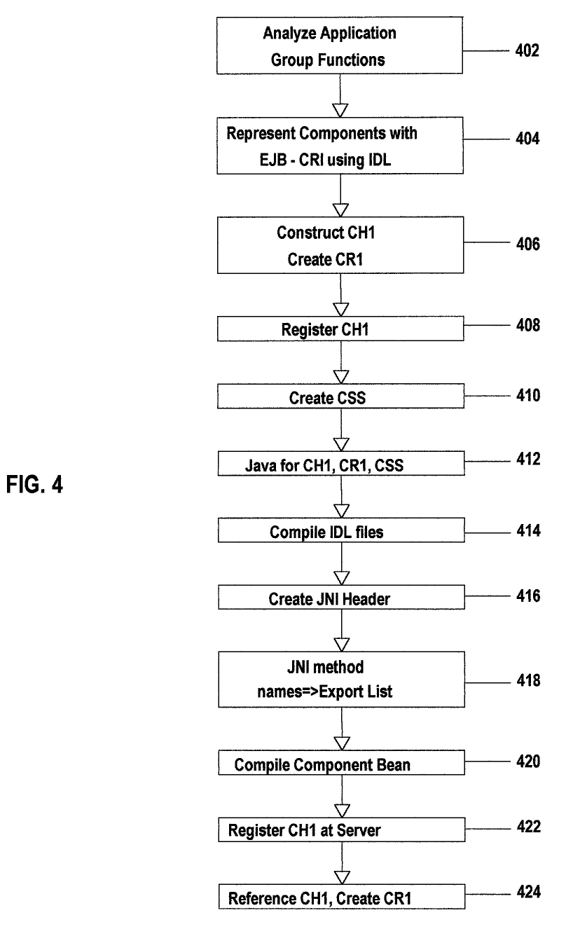

FIG. 4 illustrates a flow chart for converting an application (or components of an application) from the legacy application of FIG. 1 to the system of FIG. 2. The steps of this method include the following steps: At block 402 the application is analyzed and the functionality of the application is grouped into logical components. An Enterprise JavaBean (EJB) with the appropriate attributes and methods to physically represent the logical components is created at block 404. The Enterprise JavaBean interface for each component is created, creating an interface known as the Component Remote Interface (CRI) and is defined in a Interface Definition Language (IDL)

At block 406 a Component Home Interface (CHI) is constructed to adhere to the EJB specifications to provide a standard way to create a Component Remote Interface (CRI). The Component Home Interface (CHI) is then registered to a standard Naming Service (NS) at block 408 such that distributed applications can obtain a reference to the Component Home Interface (CHI). The Component Home Interface is defined in the Interface Definition Language (IDL).

Next, at block 410 a Component Structure Sequence CSS is created and stored so that data for an application may be passed “by value” as opposed to being passed “by reference”. This allows data to be passed in an ordered sequence without using multiple calls between applications. The Component Structure Sequence CSS is defined in the IDL.

Following that, the Java implementation files for the Component Home Interface CHI. Component Remote Interface are created at block 412. This process will be further illustrated in connection with the example of FIG. 5.

At block 414 the IDL files are compiled to generate the corresponding Java code for the new application and at block 416 the Java Native Interface (a Java command) is used to generate a Java Native Interface header file (JNI header) for incorporation into the legacy application.

Then, at block 418, the new JNI method names are added to an export list for the legacy shared library. A Component Bean file in the language of the existing legacy application is created at block 420 and includes the generate JNI header file created at the block 416 above. That Component Bean file is then compiled and linked into a shared library with the export list.

The server code is updated at block 422 to register the Component Home Interface CHI with the Naming Service to declare its availability to the distributed applications.

The client code is updated at block 424 to obtain a reference to the Component Home Interface and create a Component Remote Interface Instance to utilize its attributes and methods which encapsulate the legacy function.

FIG. 5 illustrates the principles of the present invention, particularly the method steps illustrated in FIG. 4, in connection with an example of a legacy application, in this case an application for inventory management called Makoro, a program which has been commercially available from IBM for many years. As shown in this FIG. 5, the application includes a base portion 510 which includes a UserComponent Homelmpl from the mp.ejb.user.server and interfaces up to a portion 520 and then to a portion 530 and down to a portion 540. The components resident in each portion and their origin are shown in this figure.

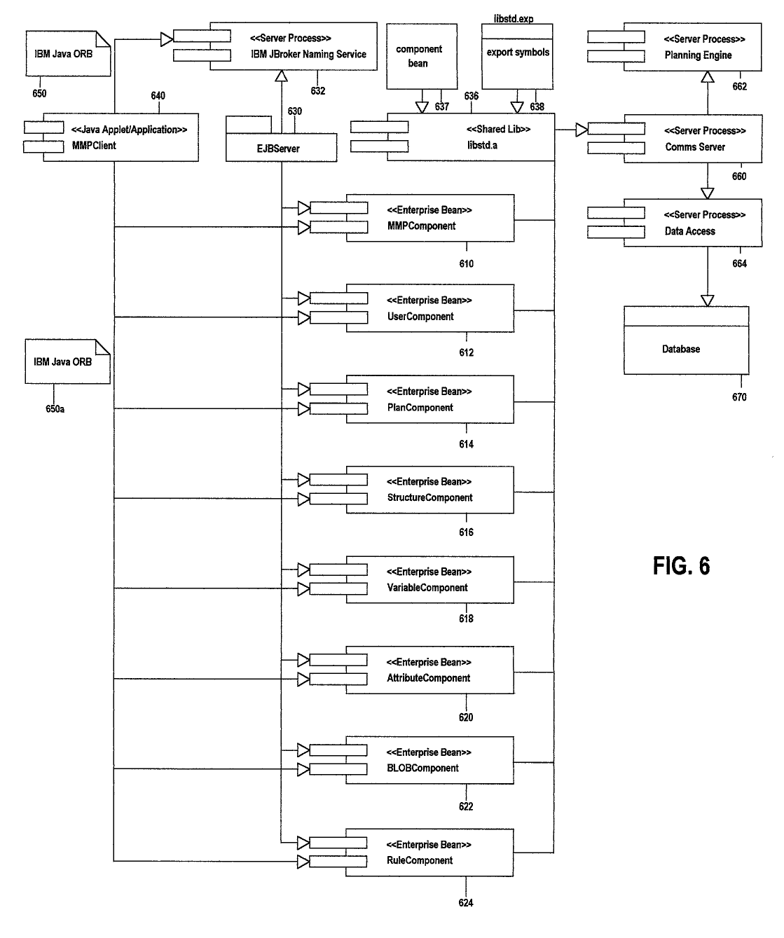

FIG. 6 illustrates some of the components of the system useful in practicing the present invention. As shown here, a plurality of components labeled 610, 612, 614, 616, 618, 620, 622 and 624 are shown on the right side of the figure. Each is comprised of an Enterprise JavaBean EJB and represents a component of the legacy application which can communicate in a distributed processing environment. Each component (e.g., 610) is coupled to the EJB server 630 (which is coupled to a server process 632 which serves as a Naming Service for the system) and to a shared library libstd.a 636 which, in turn, is coupled to file ComponentBean 637 and to export list libstd.exp 638. The EJB server 630 is a Java application server which registers each Component Home Interface (CHI) to the Naming Service process 632. The legacy application data resources 670 and other legacy processes 662 and 664 are accessed through the shared library libstd.a 636.

Individual Makoro Merchandise Planner Clients MMP Client 640 are coupled to the components through connections to the distributing processing network using an IBM Java Object Resource Broker 650a. The MMP Client 640 is also coupled to the server process 632 which includes the Naming Service function and uses the Java ORB 650. When the MMP Client 640 invokes a method on an instance on one of the components (610, 612, 614, 616, 618, 620, 622 or 624), the request is processed through the JNI to the file Component Bean 637 in the shared library libstd.a 636 and routed to the corresponding legacy process/resource. Thus, the MMP Client 640 can utilize the services of the legacy application though the standard EJB component interfaces as opposed to the MMP Client 640 directly accessing the non-standard application programming interfaces (APIs) in the shared library libstd.a 636.

The present invention can be realized in hardware, software, or a combination of hardware and software. A data processing tool according to the present invention can be realized in a centralized fashion in one computer system, or in a distributed fashion where different elements are spread across several interconnected computer systems Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

“Computer program means” or “computer program” in the present context mean any expression, in any language, code or notation, of a set of instructions intended to cause a system having an information processing capability to perform a particular function either directly or after either or both of the following a) conversion to another language, code or notation; b) reproduction in a different material form.

While the present invention is described in the context of an apparatus and a method of providing resource management, the present invention may be implemented in the form of a service where collecting, maintaining and processing of information is located apart from the server and information is communicated as needed to the server.

Of course, many modifications of the present invention will be apparent to those skilled in the relevant art in view of the foregoing description of the preferred embodiment, taken together with the accompanying drawings. For example, the description of the interface in connection with Java and Enterprise JavaBeans has been used for ease of description, but, in fact, other systems for generating an using a common interface between distributed programming components could be used to advantage in the present invention. Additionally, the location and type of information maintained about a session may be modified to suit the application. The number and type and location of the distributed data processing system and the network to connect them are subject to user's design and implementation criteria and are not an integral part of this invention. The names of the files are also a matter of design choice and system considerations. Additionally, certain features of the present invention may be useful without the corresponding use of other features without departing from the spirit of the present invention. For example, the use of passing variables by value rather than by reference avoids unnecessary calls and may be desirable in general, but a system could use the concepts of the present invention without using the by value passing of data. Accordingly, the foregoing description of the preferred embodiment should be considered as merely illustrative of the principles of the present invention and not in limitation thereof.

Having thus described the invention, what is claimed is:

1. A system for integrating a legacy application into a distributed data processing environment, the system comprising:
a legacy application located at a server coupled to a network;
an Enterprise JavaBean (EJB) wrapper surrounding the legacy application, said wrapper including an interface which allows for the distributed processing of the application over the network, whereby the EJB interface allows for the distributed processing and the legacy application retains its conventional processing.

2. A system for integrating a legacy application including the elements of claim 1 wherein the system further includes a component sequence structure so that data can be passed by value rather than by reference.

3. A method of integrating a legacy application into a distributed data processing environment, the steps of the method comprising:
analyzing a legacy application to separate its function into components;
distributing the components to different servers;
providing each component with an EJB interface;
providing an index to the components and the interface.

4. The method of integrating a legacy application into a distributed data processing environment including the steps of claim 3 and further including the step of providing listing of the sequence of data so that it may be passed between components by value rather than by reference.

5. The method of integrating a legacy application into a distributed data processing environment including the steps of claim 3 and further including the step of using a shared library accessing a component bean and a library of export symbols.

6. A program stored on a storage medium for adapting a legacy program to be used in a distributed data processing environment, the program comprising:
a first program module for providing an enterprise javabean;
a second program module for providing a function from the legacy application; and
a third program module for providing an index to the javabean and the function.

7. A program stored on a storage medium including the elements of claim 6 and further including a fourth program module which provides a common sequence structure for an application, whereby data may be passed by value and need not be passed by reference.

8. A program stored on a storage medium including the elements of claim 6 and further including an additional program module which provides a shared library for an application and the shared library includes an element for accessing a component bean and for accessing a list of export symbols.
